(19) United States
(12) Patent Application Publication
(10) Pub. No.: US 2008/0044442 A1
(43) Pub. Date: Feb. 21, 2008

(54) Container for an Inhalation Anesthetic

(75) Inventors: Joel Swinson, Evans, GA (US); Barry Jones, Martinez, GA (US); Mark Reid Frye, Williston, SC (US)

Correspondence Address: NORRIS, MCLAUGHLIN & MARCUS, PA, 875 THIRD AVENUE, 18TH FLOOR, NEW YORK, NY, 10022, US

(73) Assignee: HALOCARBON PRODUCTS CORPORATION, River Edge, NJ (US)

(21) Appl. No.: 11/571,967

(22) PCT Filed: Jul. 13, 2005
(86) PCT No.: PCT/US05/24820

§ 371 Date: May 9, 2007

Related U.S. Application Data
(60) Provisional application No. 60/588,508, filed on Jul. 15, 2004.

(51) Int. Cl. A61J 1/00; B65D 1/02

(52) U.S. Cl. 424/400; 424/451; 424/457

(57) ABSTRACT

The specification and drawings describe and show one preferred embodiment or a small number of preferred embodiments of the present invention in the form of a container constructed from or lined with a material comprising a copolymer of acrylonitrile, methyl acrylate, and butadiene, said container defining an interior space constructed to contain therein, external to a patient's body, an inhalation anesthetic; and a volume of sevoflurane contained in said interior space defined by said container. It is emphasized that this abstract is provided to comply with the rules requiring an abstract which will allow a searcher or other reader quickly to ascertain the subject matter of the technical disclosure. It is submitted with the understanding that it will not be used to interpret or limit the scope or meaning of the appended issued claims.

### BACKGROUND OF THE INVENTION

1. Field of the Invention

The present invention relates to a container for an inhalation anesthetic and a method for storing an inhalation anesthetic.

2. Description of Related Art

Fluoroether inhalation anesthetic agents such as sevoflurane (fluoromethyl-2,2,2-trifluoro-1-(trifluoromethyl)ethyl ether), enflurane (2-chloro-1,1,2-trifluoroethyl difluoromethyl ether), isoflurane (1-chloro-2,2,2-trifluoroethyl difluoromethyl ether), methoxyflurane (2,2-dichloro-1,1-difluoroethyl methyl ether) and desflurane (2-difluoromethyl-1,2,2,2-tetrafluoroethyl ether) are typically distributed in containers constructed of glass. Although these fluoroether agents have been shown to be excellent anesthetic agents, U.S. Pat. No. 5,990,176 suggests that under certain conditions the fluoroether agent and the glass container may interact, thereby facilitating degradation of the fluoroether agent. According to U.S. Pat. No. 5,990,176, this interaction is believed to result from the presence of Lewis acids in the glass container material. According to U.S. Pat. No. 5,990,176, Lewis acids have an empty orbital, which can accept an unshared pair of electrons and thereby provide a potential site for reaction with the alpha fluoroether moiety (—C—O—C—F) of the fluoroether agent. According to U.S. Pat. No. 5,990,176, degradation of these fluoroether agents in the presence of a Lewis acid may result in the production of degradation products such as hydrofluoric acid.

The glass material currently used to contain these fluoroether agents is referred to as Type III glass. This material contains silicon dioxide, calcium hydroxide, sodium hydroxide and aluminum oxide. Type III glass provides a barrier to the transmission of vapor through the wall of the container, thereby preventing the transmission of the fluoroether agent therethrough and preventing the transmission of other vapors into the container. However, according to U.S. Pat. No. 5,990,176, the aluminum oxide contained in glass materials such as type III glass tend to act as Lewis acids when exposed directly to the fluoroether agent, thereby facilitating degradation of the fluoroether agent. According to U.S. Pat. No. 5,990,176, the degradation products produced by this degradation, e.g., hydrofluoric acid, may etch the interior surface of the glass container, thereby exposing additional quantities of aluminum oxide to the fluoroether compound and thereby facilitating further degradation of the fluoroether compound. According to U.S. Pat. No. 5,990,176, in some cases, the resulting degradation products may compromise the structural integrity of the glass container.

As taught in U.S. Pat. Nos. 6,074,668, 6,083,514, 6,162,443 and 6,558,679 (hereinafter “the container patents”), efforts have been made to inhibit the reactivity of glass to various chemicals. For example, it has been found that treating glass with sulfur will protect the glass material in some cases. However, it will be appreciated that the presence of sulfur on the surface of a glass container is not acceptable in many applications.

Furthermore, as taught in these container patents, glass containers present a breakage concern. As taught therein, for example, glass containers may break when dropped or otherwise subjected to a sufficient force, either in use or during shipping and handling. As taught therein, such breakage can cause medical and incidental personnel to be exposed to the contents of the glass container. In this regard, inhalation anesthetic agents evaporate quickly. As taught therein, thus, if the glass container contains an inhalation anesthetic such as sevoflurane, breakage of the container may necessitate evacuation of the area immediately surrounding the broken container, e.g., an operating room or medical suite.

As taught in these container patents, efforts to address breakage concerns typically have involved coating the exterior, non-product contact surfaces of the glass with polyvinyl chloride (PVC) or synthetic thermoplastic resin such as Surlyn® (a registered trademark of E. I. Du Pont De Nemours and Company). As taught therein, these efforts increase the cost of the containers, are not aesthetically pleasing, and do not overcome the above-discussed problems related to degradation which can occur when using glass to contain fluoroether-containing inhalation anesthetic agents.

As taught in these container patents, for these reasons, it is desirable to provide a container constructed from a material other than glass in order to store, transport, and dispense inhalation anesthetics, thereby avoiding the above-discussed shortcomings of glass. As taught therein, the preferred material does not contain Lewis acids, which can promote the degradation of the inhalation anesthetic agent, provides a sufficient barrier to vapor transmission into and out of the container, and increases the container's resistance to breakage relative to a glass container.

According to U.S. Pat. No. 6,074,668, such a container is provided constructed from or lined with polyethylene napthalate. According to U.S. Pat. No. 6,083,514, such a container is provided constructed from or lined with polymethylpentene. According to U.S. Pat. No. 6,162,443, such a container is constructed from or lined with one or more of polypropylene, polyethylene, and ionomeric resins. According to U.S. Pat. No. 6,558,679, such a container is provided constructed from or lined with polyesters.

There remains a need to find other containers solving one or more of the problems discussed above.

### BRIEF SUMMARY OF THE INVENTION

The present invention is directed to a pharmaceutical product comprising a container constructed from a material comprising a copolymer of acrylonitrile, methyl acrylate, and butadiene. The container defines an interior space in which a volume of a fluoroether-containing inhalation anesthetic is contained.

In an alternative embodiment, the present invention is directed to a pharmaceutical product in which a container defining an interior space has an interior surface adjacent to the interior space. The interior surface of the container is constructed from a material comprising a copolymer of acrylonitrile, methyl acrylate, and butadiene. A volume of a fluoroether-containing inhalation anesthetic is contained in the interior space of the container.

The present invention is further directed to a method for storing an inhalation anesthetic. The method comprises the step of providing a predetermined volume of a fluoroether-containing inhalation anesthetic. A container also is provided, the container being constructed from a material comprising a copolymer of acrylonitrile, methyl acrylate, and butadiene. The container defines an interior space. The predetermined volume of fluoroether-containing inhalation anesthetic is placed in the interior space of the container.

In an alternative embodiment of the method of the present invention, a predetermined volume of a fluoroether-containing inhalation anesthetic is provided. In addition, a container having an interior surface defining an interior space is provided. The interior surface of the container is constructed from a material comprising a copolymer of acrylonitrile, methyl acrylate, and butadiene. The predetermined volume of a fluoroether-containing inhalation anesthetic is placed in the interior space of the container.

### BRIEF DESCRIPTION OF THE SEVERAL VIEWS OF THE DRAWINGS

For a more complete understanding of the present invention, reference may be had to the following Detailed Description read in connection with the accompanying drawing in which:

FIG. 1 is cross-sectional view of a pharmaceutical product constructed in accordance with the present invention.

It is understood that the references to the drawing herein are meant to be exemplary of the preferred embodiment(s) described herein, and that neither the drawing itself, nor the reference numerals on the drawing are meant to be limiting of the invention in any respect.

### DETAILED DESCRIPTION OF THE INVENTION

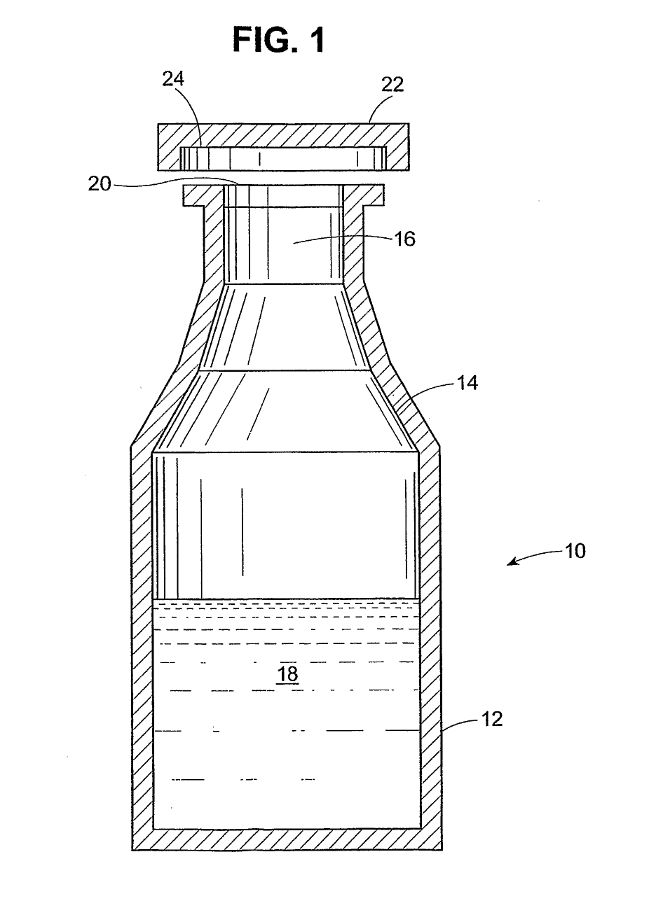

A pharmaceutical product constructed in accordance with the present invention is generally indicated at 10 of FIG. 1. Pharmaceutical product 10 includes container 12 having an interior surface 14. Interior surface 14 defines an interior space 16 within container 12. An inhalation anesthetic 18 is contained within interior space 16 of container 12. In a preferred embodiment of the present invention, inhalation anesthetic 18 is a fluoroether compound. Fluoroether-containing inhalation anesthetics useful in connection with the present invention include, but are not necessarily limited to, sevoflurane, enflurane, isoflurane, methoxyflurane, and desflurane. Inhalation anesthetic 18 is a fluid, and may include a liquid phase, a vapor phase, or both liquid and vapor phases. FIG. 1 depicts inhalation anesthetic 18 in a liquid phase.

The purpose of container 12 is to contain inhalation anesthetic 18. In the embodiment of the present invention depicted in FIG. 1, container 12 is in the shape of a bottle. However, it will be appreciated that container 12 can have a variety of configurations and volumes without departing from the spirit and scope of the present invention. For example, container 12 can be configured as a shipping vessel for large volumes (e.g., tens or hundreds of liters) of inhalation anesthetic 18. Such shipping vessels can be rectangular, spherical, or oblong in cross-section without departing from the intended scope of the invention.

Containers constructed from a material that contains a copolymer of acrylonitrile, methyl acrylate, and butadiene provide suitable container characteristics when used with pharmaceutical and/or food products. One of ordinary skill will appreciate that there are many different types of acrylonitrile/methyl acrylate/butadiene copolymers, which vary in their molecular weight, additives, and acrylate content. These polymers can be categorized into two distinct groups; namely, copolymers and blends. It may be preferable that the material from which container 12 of the present invention is constructed comprises an acrylonitrile/methyl acrylate/butadiene copolymer blended with a polyolefin such as polypropylene or high-density polyethylene. However, it will be appreciated that certain copolymers can also be used in connection with the present invention

In addition to the foregoing, copolymers of acrylonitrile, methyl acrylate, and butadiene do not contain Lewis acids and therefore should not pose any threat of facilitating the degradation of a fluoroether-containing inhalation anesthetic contained in a container constructed therefrom as described in U.S. Pat. No. 5,990,176.

An example of a copolymer of acrylonitrile, methyl acrylate, and butadiene material useful in connection with the present invention is a copolymer of acrylonitrile, methyl acrylate, and butadiene called Barex® resin (trademark of BP Petrochemicals Company), a covalently crosslinked 1,3-butadiene-based copolymer of methyl acrylate and acrylonitrile. One of ordinary skill will appreciate that other copolymers containing different ratios of these three monomers can be used without departing from the scope of the invention set forth in the appended claims.

In a first embodiment of the present invention, container 12 is constructed of a single layer of material. That is, container 12 is substantially homogenous throughout its thickness. In this embodiment, as above discussed, container 12 is constructed of a material that contains a copolymer of acrylonitrile, methyl acrylate, and butadiene.

In an alternative embodiment of the present invention, container 12 is multi-laminar. As used herein, the term multi-laminar is intended to include (i) materials constructed of more than one lamina where at least two of the lamina are constructed of different materials, i.e., materials that are chemically or structurally different, or materials that have different performance characteristics, wherein the lamina are bonded to one another or otherwise aligned with one another so as to form a single sheet; (ii) materials having a coating of a different material; (iii) materials having a liner associated therewith, the liner being constructed of a different material; and (iv) known variations of any of the above. In this alternative embodiment of the present invention, interior surface 14 of container 12 is preferably constructed of a material containing a copolymer of acrylonitrile, methyl acrylate, and butadiene.

As depicted in FIG. 1, container 12 defines an opening 20. Opening 20 facilitates the filling of container 12 and provides access to the contents of container 12, thereby allowing the contents to be removed from container 12 when they are needed. In the embodiment of the present invention depicted in FIG. 1, opening 20 is a mouth of a bottle. However, it will be appreciated that opening 20 can have a variety of known configurations without departing from the scope of the present invention.

Cap 22 is constructed to seal fluidly opening 20, thereby fluidly sealing inhalation anesthetic 18 within container 12. Cap 22 can be constructed of a variety of known materials. However, it is preferable that cap 22 be constructed from a material containing a copolymer of acrylonitrile, methyl acrylate, and butadiene. In an alternative embodiment of the present invention, cap 22 has an interior surface 24 that is constructed from a material containing a copolymer of acrylonitrile, methyl acrylate, and butadiene. In another alternative embodiment of the present invention, cap 22, and/or interior surface 24 thereof, is constructed of a material containing polyethylene. In still another alternative embodiment of the present invention, cap 22, and/or interior surface 24 thereof, is constructed of a material containing polyethylene napthalate.

Cap 22 and container 12 can be constructed such that cap 22 can be threadingly secured thereto. Containers and caps of this type are well known. Alternative embodiments of cap 22 and container 12 are also possible and will be immediately recognized by those of ordinary skill in the relevant art. Such alternative embodiments include, but are not necessarily limited to, caps that can be “snap-fit” on containers, caps that can be adhesively secured to containers, and caps that can be secured to containers using known mechanical devices, e.g., a ferrule. In the preferred embodiment of the present invention, cap 22 and container 12 are configured such that cap 22 can be removed from container 12 without causing permanent damage to either cap 22 or container 12, thereby allowing a user to reseal opening 20 with cap 22 after the desired volume of inhalation anesthetic 18 has been removed form container 12.

Container 12 may include additional features. For example, container 12 can be configured to include a system for dispensing inhalation anesthetic 18 from container 12 into an anesthesia vaporizer. U.S. Pat. No. 5,505,236 to Grabenkort discloses such a system.

Methods for making containers of the type used in the present invention are known in the art. For example, it is known that copolymers of acrylonitrile, methyl acrylate, and butadiene must be dried to a moisture level of less than about 0.17% prior to processing in order to yield the optimal physical properties in container 12 and cap 22. Proper dryness typically is achieved by drying the resin in a dryer (140-150° F., dew point 0-20° F.) for 2-4 hours before molding. A preferred method for making containers 12 and caps 22 useful in connection with the present invention entails the injection-stretch-blow molding of a material containing a copolymer of acrylonitrile, methyl acrylate, and butadiene. Machines manufactured by AOKI Technical Laboratory, Inc. of Tokyo, Japan are particularly useful in performing this molding operation. The material containing the copolymer of acrylonitrile, methyl acrylate, and butadiene is injection molded into a preform, which is then transferred to a blow station where it is stretched and blown to form the container. No annealing or further after treatment is needed after this process, which may be performed with either one-stage or two-stage equipment.

The method of the present invention includes the step of providing a predetermined volume of a fluoroether-containing inhalation anesthetic 18. The fluoroether-containing inhalation anesthetic 18 can be one or more of sevoflurane, enflurane, isoflurane, methoxyflurane, and desflurane. A container 12 constructed in accordance with the above-described pharmaceutical product also is provided. In particular, container 12 defines an interior space and is constructed of a material containing a copolymer of acrylonitrile, methyl acrylate, and butadiene. The method of the present invention further includes the step of placing the predetermined volume of fluoroether-containing inhalation anesthetic 18 into the interior space defined by the container.

In an alternative embodiment of the method of the present invention, a predetermined volume of a fluoroether-containing inhalation anesthetic 18 is provided. The fluoroether-containing inhalation anesthetic 18 can be one or more of sevoflurane, enflurane, isoflurane, methoxyflurane, and desflurane. A container 12 constructed in accordance with the above-described product also is provided. In particular, container 12 has an interior surface 14, which defines an interior space 16. Interior surface 14 of container 12 is constructed of a material containing a copolymer of acrylonitrile, methyl acrylate, and butadiene. The method further comprises the step of placing the predetermined volume of fluoroether-containing inhalation anesthetic into the interior space defined by the container.

In each of the embodiments of the method of the present invention, container 12 can define an opening 20 therein whereby opening 20 provides fluid communication between interior space 16 of container 12 and an external environment of container 12. Each of the embodiments of the present invention may further include the step of providing a cap 22 constructed of a material compatible with the inhalation anesthetic. In the alternative, cap 22 can be constructed such that an interior surface 24 thereof is constructed of a material compatible with the inhalation anesthetic. The method of the present invention further comprises the step of sealing the opening defined by container 12 with cap 22.

It should be understood that the preceding is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

What is claimed is:

1. An inhalation anesthetic product comprising: a container constructed from a material comprising a copolymer of acrylonitrile, methyl acrylate, and butadiene, said container defining an interior space constructed to contain therein, external to a patient's body, an inhalation anesthetic; and a volume of a fluoroether inhalation anesthetic compound contained in said interior space defined by said container.

2. An inhalation anesthetic product in accordance with claim 1, wherein said container defines an opening therein, said opening providing fluid communication between said interior space defined by said container and an external environment of said container, said inhalation anesthetic product further comprising a cap, said cap constructed to seal said opening defined in said container, said cap constructed from a material comprising a compound selected from a group consisting of an acrylonitrile/methyl acrylate/butadiene copolymer, polyethylene, and polyethylene napthalate.

3. An inhalation anesthetic product in accordance with claim 1, wherein said container defines an opening therein, said opening providing fluid communication between said interior space defined by said container and an external environment of said container, said inhalation anesthetic product further comprising a cap having an interior surface, said cap constructed to seal said opening defined in said container, said interior surface of said cap constructed from a material comprising a compound selected from a group consisting of an acrylonitrile/methyl acrylate/butadiene copolymer, polyethylene, and polyethylene napthalate.

4. An inhalation anesthetic product in accordance with claim 1, wherein the fluoroether inhalation anesthetic compound is sevoflurane.

5. An inhalation anesthetic product comprising: a container defining an interior space, constructed to contain therein, external to a patient's body, an inhalation anesthetic, said container having an interior surface adjacent to said interior space, said interior surface constructed from a material comprising a copolymer of acrylonitrile, methyl acrylate, and butadiene; and a volume of a fluoroether inhalation anesthetic compound contained in said container.

6. An inhalation anesthetic product in accordance with claim 5, wherein said container defines an opening therein, said opening providing fluid communication between said interior space defined by said container and an external environment of said container, said inhalation anesthetic product further comprising a cap, said cap constructed to seal said opening defined in said container, said cap constructed from a material comprising a compound selected from a group consisting of an acrylonitrile/methyl acrylate/butadiene copolymer, polyethylene, and polyethylene napthalate.

7. An inhalation anesthetic product in accordance with claim 5, wherein said container defines an opening therein, said opening providing fluid communication between said interior space defined by said container and an external environment of said container, said inhalation anesthetic product further comprising a cap having an interior surface, said cap constructed to seal said opening defined in said container, said interior surface of said cap constructed from a material comprising a compound selected from a group consisting of an acrylonitrile/methyl acrylate/butadiene copolymer, polyethylene, and polyethylene napthalate.

8. An inhalation anesthetic product in accordance with claim 5, wherein the fluoroether inhalation anesthetic compound is sevoflurane.

9. A method for storing an inhalation anesthetic external to a patient's body, said method comprising the steps of:
providing a predetermined volume of a fluoroether inhalation anesthetic compound;
providing a container defining an interior space, said container constructed from a material comprising a copolymer of acrylonitrile, methyl acrylate, and butadiene; and
placing said predetermined volume of said fluoroether inhalation anesthetic compound in said interior space defined by said container.

10. A method for storing an inhalation anesthetic in accordance with claim 9, wherein said container defines an opening therein, said opening providing fluid communication between said interior space defined by said container and an external environment of said container, said method further comprising the steps of:
providing a cap constructed to seal said opening defined in said container, said cap constructed from a material comprising a compound selected from a group consisting of an acrylonitrile/methyl acrylate/butadiene copolymer, polyethylene, and polyethylene napthalate; and
sealing said opening defined in said container with said cap.

11. A method for storing an inhalation anesthetic in accordance with claim 9, wherein said container defines an opening therein, said opening providing fluid communication between said interior space defined by said container and an external environment of said container, said method further comprising the steps of:
providing a cap constructed to seal said opening defined in said container, said cap having an interior surface constructed from a material comprising a compound selected from a group consisting of an acrylonitrile/methyl acrylate/butadiene copolymer, polyethylene, and polyethylene napthalate; and
sealing said opening defined in said container with said cap.

12. A method for storing an inhalation anesthetic in accordance with claim 9, wherein the fluoroether inhalation anesthetic compound is sevoflurane.

13. A method for storing an inhalation anesthetic external to a patient's body, said method comprising the steps of:
providing a predetermined volume of a fluoroether inhalation anesthetic compound;
providing a container defining an interior space, said container having an interior wall adjacent said interior space defined by said container, said interior wall of said container constructed from a material comprising a copolymer of acrylonitrile, methyl acrylate, and butadiene; and
placing said predetermined volume of said fluoroether inhalation anesthetic compound in said interior space defined by said container.

14. A method for storing an inhalation anesthetic in accordance with claim 13, wherein said container defines an opening therein, said opening providing fluid communication between said interior space defined by said container and an external environment of said container, said method further comprising the steps of:
providing a cap constructed to seal said opening defined in said container, said cap comprising a compound selected from a group consisting of an acrylonitrile/methyl acrylate/butadiene copolymer, polyethylene, and polyethylene napthalate; and
sealing said opening defined in said container with said cap.

15. A method for storing an inhalation anesthetic in accordance with claim 13, wherein said container defines an opening therein, said opening providing fluid communication between said interior space defined by said container and an external environment of said container, said method further comprising the steps of:
providing a cap constructed to seal said opening defined in said container, said cap having an interior surface constructed from a material comprising a compound selected from a group consisting of an acrylonitrile/methyl acrylate/butadiene copolymer, polyethylene, and polyethylene napthalate; and
sealing said opening defined in said container with said cap.

16. A method for storing an inhalation anesthetic in accordance with claim 13, wherein the fluoroether inhalation anesthetic compound is sevoflurane.
